(19) United States
(12) Patent Application Publication
(10) Pub. No.: US 2011/0245101 A1
(43) Pub. Date: Oct. 6, 2011

(54) CO-LOCALIZATION AFFINITY ASSAYS

(75) Inventors: Mark S. Chee, Encinitas, CA (US); Igor A. Kozlov, San Diego, CA (US); Anita D. Wentworth, San Diego, CA (US); Stephanie J. Kosakovsky Pond, San Diego, CA (US)

(73) Assignee: Prognosys Biosciences, Inc., La Jolla, CA (US)

(21) Appl. No.: 13/079,878

(22) Filed: Apr. 5, 2011

Related U.S. Application Data
(60) Provisional application No. 61/321,129, filed on Apr. 5, 2010.

(51) Int. Cl. C40B 30/04

(52) U.S. Cl. 506/9

(57) ABSTRACT

The invention provides a new assay format for high throughput molecular binding studies at a single molecule level. The invention enables creation of binding event identifiers in a highly parallel way. Individual binding events occur between two agents of a binding pair, e.g., a protein-based binding pair or a binding pair comprising a protein and a chemical moiety. The binding event identifier created through the binding of the two binding agents is unique to that pair, and identification of the binding event identifier is indicative of the binding of these specific may be assessed through a readout that is digital in nature. The invention enables very large sets of thousands or more of different binding agents or potential binding agents to be assayed simultaneously, resolving millions or more of potential interactions, and distinguishing specific interactions from those that are less specific.

### CROSS-REFERENCE TO RELATED APPLICATIONS

This application claims the benefit of U.S. Provisional Patent Application No. 61/321,129 filed Apr. 5, 2010 and is incorporated herein by reference.

### FIELD OF THE INVENTION

This invention relates to assays of biological molecules, and more particularly to robust, multiplexed assays with a large dynamic range for detecting binding events between many types of biological molecules including proteins, small molecules, carbohydrates and the like.

### BACKGROUND OF THE INVENTION

In the following discussion certain articles and methods will be described for background and introductory purposes. Nothing contained herein is to be construed as an “admission” of prior art. Applicant expressly reserves the right to demonstrate, where appropriate, that the articles and methods referenced herein do not constitute prior art under the applicable statutory provisions.

Comprehensive gene expression analysis and protein analysis have been useful tools in understanding mechanisms of biology. The advent of DNA microarrays allowed the study of a larger number of labeled molecules than ever before, enabled by the specificity of nucleic acid hybridization, but even these screening methods have a small dynamic range and a problem of background caused by non-specific hybridization of similar nucleic acids. Currently, DNA arrays for RNA expression profiling are being replaced by high throughput sequencing techniques that have much greater dynamic range and produce a readout that is digital in nature, but such sequencing techniques are designed for the readout of nucleic acids.

Peptide or protein arrays enable high-throughput screening of compounds that may interact with one or more of the peptides or proteins, and are useful in various applications including basic scientific research and drug discovery. For example, an array of peptide or protein molecules potentially suitable as modulators for a particular biological receptor may be screened with respect to that receptor. The promise of peptidic arrays, however, has been not been fully realized. This is in large part due to manufacturing challenges, but other problems have been encountered as well. In particular, the screening of arrayed peptides or proteins generally may be carried out against only relatively few labeled molecules at a time.

There exists a need for methods and compositions for high throughput analysis of molecular interactions, including interactions between peptides, proteins, small molecules, carbohydrates and the like. In particular, there is a need for high throughput molecular interaction studies at a single molecule level. The present invention addresses this need.

### SUMMARY OF THE INVENTION

This Summary is provided to introduce a selection of concepts in a simplified form that are further described below in the Detailed Description. This Summary is not intended to identify key or essential features of the claimed subject matter, nor is it intended to be used to limit the scope of the claimed subject matter. Other features, details, utilities, and advantages of the claimed subject matter will be apparent from the following written Detailed Description including those aspects illustrated in the accompanying drawings and defined in the appended claims.

The invention provides a new assay format for high-throughput molecular binding studies at a single molecule level. The invention utilizes co-location of two or more unique nucleic acid tags to create binding event identifiers that are indicative of selective binding of two or more binding agents, e.g., a protein-based binding pair or a binding pair comprising a protein and a different chemical moiety.

In one embodiment, the invention provides a method for identifying binding agents that form a binding pair, comprising: providing a first set of binding constructs immobilized on a support surface, where each binding construct of the first set of binding constructs comprises a first binding agent and a first nucleic acid tag unique to the first binding agent; providing a second set of binding constructs in solution, where each binding construct of the second set of binding constructs comprises a second binding agent and a second nucleic acid tag unique to the second binding agent, and where either or both of the first and second sets of binding constructs comprises at least ten different binding agents; combining the first and second sets of binding constructs under conditions to allow the first binding agents and the second binding agents to form binding pairs thereby co-locating the first nucleic acid tags and the second nucleic acid tags; creating binding event identifiers from the co-located first and second nucleic acid tags; and determining a sequence of each binding event identifier; wherein the sequence of each binding event identifier identifies the binding pair and the binding agents that form the binding pair.

In preferred aspects of this embodiment, the sequence of the binding event identifier is determined by digital readout, and in more preferred embodiments the sequence of the binding event identifier is determined by high throughput digital sequencing.

In some aspect of this embodiment, either or both of the first and second sets of binding constructs comprises at least twenty-five different binding agents, and in other aspects either or both of the first and second sets of binding constructs comprises at least one hundred different binding agents, at least one thousand different binding agents, at least five thousand different binding agents, at least ten thousand different binding agents, at least fifty thousand different binding agents, at least one hundred thousand different binding agents, at least five hundred thousand different binding agents, at least one million different binding agents or more. In preferred aspects, sequences of the binding event identifiers are determined in parallel, and in some aspects the sequences of at least one thousand binding event identifiers are determined in parallel, and in other aspects, the sequences of at least one hundred thousand binding event identifiers, at least five hundred thousand binding event identifiers, at least one million binding event identifiers or more are determined in parallel.

In some aspects, the binding event identifier is created by coupling the first and second nucleic acid tags, where in some aspects the coupling of the first and second tags is accomplished by ligation, and in other aspects the coupling of the first and second tags is accomplished by primer extension. In some aspects, one or both of the first and second binding constructs further comprise a primer sequence. In some aspects, the method further comprises the step of amplifying the binding event identifier after the creating step and before the determining step.

In some aspects, at least one of the first and second binding agents is a peptide.

In some aspects, both the first and second binding agents are peptides. In yet other aspects, the first binding agent is a peptide and the second binding agent is an antibody. In yet other aspects, the first binding agent is a peptide and the second binding agent is a small molecule. In yet alternative aspects, either the first or second binding agent is an aptamer, and in some aspects, the first binding agent is a peptide and the second binding agent is an aptamer.

In some aspects, the method further comprises the step of adding a third binding agent in the combining step. In other aspects, the method further comprises the step of identifying binding agents that bind promiscuously, and in some aspects, data from promiscuous binding agents is subtracted from binder identifier results of the determining step and, in some aspects, a quantitative metric can be derived for the extent of promiscuity of promiscuous binding agents. In some aspects of the method, false positives are identified within the binding event identifiers and data from the false positives subtracted from binder identifier results of the determining step. Also, some aspects further comprise the step of determining the frequency of each binding event identifier sequenced.

In other embodiments, the invention provides a method for identifying binding agents that form a binding pair, comprising: providing a first set of binding constructs immobilized on a support surface, where each binding construct of the first set of binding constructs comprises a first binding agent, a first primer region and a first nucleic acid tag unique to the first binding agent; providing a second set of binding constructs in solution, where each binding construct of the second set of binding constructs comprises a second binding agent, a second primer region and a second nucleic acid tag unique to the second binding agent, and where either or both of the first and second sets of binding constructs comprises at least ten different binding agents; combining the first and second sets of binding constructs under conditions to allow the first binding agents and the second binding agents to form binding pairs thereby co-locating the first nucleic acid tags and the second nucleic acid tags; creating binding event identifiers from the co-located first and second nucleic acid tags; and determining a sequence of at least one thousand binding event identifiers, where the sequence of each binding event identifier identifies the binding pair and the binding agents that form the binding pair; and determining the frequency of each binding event identifier sequenced. In some aspects of this embodiment, the sequence of the binding event identifier is determined by digital readout, and in more preferred embodiments the sequence of the binding event identifier is determined by high throughput digital sequencing. Also in some aspects, the method further comprises the step of amplifying the binding event identifier after the creating step and before the determining step.

In yet other embodiments, the invention provides a method for characterizing the specificity of binding between binding agents that form a binding pair, comprising: providing a first set of binding constructs immobilized on a support surface, where each binding construct of the first set of binding constructs comprises a first binding agent, a first primer region and a first nucleic acid tag unique to the first binding agent; providing a second set of binding constructs in solution, where each binding construct of the second set of binding constructs comprises a second binding agent, a second primer region and a second nucleic acid tag unique to the second binding agent, and where either or both of the first and second sets of binding constructs comprises at least ten different binding agents; combining the first and second sets of binding constructs under conditions to allow the first binding agents and the second binding agents to form binding pairs, thereby co-locating the first nucleic acid tags and the second nucleic acid tags; creating binding event identifiers from the co-located first and second nucleic acid tags; and determining a sequence of the binding event identifiers; where the sequence of the binding event identifier identifies the binding pair and the binding agents that form the binding pair. In some aspects of this embodiment, the sequence of the binding event identifier is determined by digital readout, and in more preferred embodiments the sequence of the binding event identifier is determined by high throughput digital sequencing. Also in some aspects, the method further comprises the step of amplifying the binding event identifier after the creating step and before the determining step.

### DESCRIPTION OF THE FIGURES

FIG. 1 illustrates a first general scheme for creating a binding event identifier to detect a binding event between two binding agents.

FIG. 2 illustrates one exemplary binding construct immobilized to a support surface.

FIGS. 3A through 3D illustrate four exemplary binding constructs that can be used in the assays of the invention.

FIG. 4 illustrates one method for creating a binding construct on a support surface.

FIG. 5 illustrates an alternative method for creating a binding construct on a support surface.

FIG. 6 illustrates yet another method for creating a binding construct on a support surface.

FIGS. 7A through 7D illustrate four exemplary binding constructs useful in the assays of the invention.

FIG. 8 illustrates binding pair interactions that can be used in the assays of the invention.

FIG. 9 illustrates a binding pair interaction that can be used in the assays of the invention.

FIG. 10 illustrates a binding pair interaction that can be used in the displacement mechanism reactions of the invention.

FIG. 11 illustrates an exemplary assay for identifying binding events between first and second binding agents.

FIG. 12 illustrates an alternative exemplary assay for identifying binding events between first and second binding agents.

FIG. 13 illustrates yet another exemplary assay for identifying binding events between first and second binding agents.

It should be noted that the features of the various binding constructs, anchors, anchor oligonucleotides, binding agents and various regions within the binding constructs, anchors, anchor oligonucleotides, and binding agents (such as, for example, coding regions, primer sites, ligation sites, unique nucleic acid tags, capture agents, binding agents, and the like) are not drawn to scale; rather, the features are presented in a representational manner only.

### DEFINITIONS

The terms used herein are intended to have the plain and ordinary meaning as understood by those of ordinary skill in the art. The following definitions are intended to aid the reader in understanding the present invention, but are not intended to vary or otherwise limit the meaning of such terms unless specifically indicated.

The term “binding agent” as used herein refers to any binding agent that selectively binds to a molecule of interest.

The term “binding pair” means any two molecules (binding agents) that are known to bind selectively to one another. In the case of two proteins, the proteins bind selectively to one another with a high affinity as described in more detail herein. The term also includes complementary nucleic acid molecules that selectively hybridize at or above a desired melting temperature.

“Complementary” or “substantially complementary” refers to the hybridization or base pairing or the formation of a duplex between nucleotides or nucleic acids, such as, for instance, between two strands of a double-stranded DNA molecule or between an oligonucleotide primer and a primer binding site on a single-stranded nucleic acid. Complementary nucleotides are, generally, A and T (or A and U), and C and G. Two single-stranded RNA or DNA molecules are said to be substantially complementary when the nucleotides of one strand, optimally aligned and compared and with appropriate nucleotide insertions or deletions, pair with at least about 80% of the other strand, usually at least about 90% to about 95%, and even about 98% to about 100%.

“Hybridization” refers to the process in which two single-stranded polynucleotides bind non-covalently to form a stable double-stranded polynucleotide. The resulting (usually) double-stranded polynucleotide is a “hybrid” or “duplex.” “Hybridization conditions” will typically include salt concentrations of approximately less than 1 M, often less than about 500 mM and may be less than about 200 mM. A “hybridization buffer” is a buffered salt solution such as 5% SSPE, or other such buffers known in the art. Hybridization temperatures can be as low as 5° C., but are typically greater than 22° C., and more typically greater than about 30° C., and typically in excess of 37° C. Hybridizations are often performed under stringent conditions, i.e., conditions under which a primer will hybridize to its target subsequence but will not hybridize to the other, non-complementary sequences. Stringent conditions are sequence-dependent and are different in different circumstances. For example, longer fragments may require higher hybridization temperatures for specific hybridization than short fragments. As other factors may affect the stringency of hybridization, including base composition and length of the complementary strands, presence of organic solvents, and the extent of base mismatching, the combination of parameters is more important than the absolute measure of any one parameter alone. Generally stringent conditions are selected to be about 5° C. lower than the Tₘ for the specific sequence at a defined ionic strength and pH. Exemplary stringent conditions include a salt concentration of at least 0.01 M to no more than 1 M sodium ion concentration (or other salt) at a pH of about 7.0 to about 8.3 and a temperature of at least 25° C. For example, conditions of 5xSSPE (750 mM NaCl, 50 mM sodium phosphate, 5 mM EDTA at pH 7.4) and a temperature of approximately 30° C. are suitable for allele-specific hybridizations, though a suitable temperature depends on the length and/or GC content of the region hybridized.

“Ligation” means to form a covalent bond or linkage between the termini of two or more nucleic acids, e.g., oligonucleotides and/or polynucleotides, in a template-driven reaction. The nature of the bond or linkage may vary widely and the ligation may be carried out enzymatically or chemically. As used herein, ligations are usually carried out enzymatically to form a phosphodiester linkage between a 5′ carbon terminal nucleotide of one oligonucleotide with a 3′ carbon of another nucleotide.

“Nucleic acid”, “oligonucleotide”, “oligo” or grammatical equivalents used herein refers generally to at least two nucleotides covalently linked together. A nucleic acid generally will contain phosphodiester bonds, although in some cases nucleic acid analogs may be included that have alternative backbones such as phosphoramidite, phosphorodithioate, or methylphophoroamidite linkages; or peptide nucleic acid backbones and linkages. Other analog nucleic acids include those with bicyclic structures including locked nucleic acids, positive backbones, non-ionic backbones and non-ribose backbones. Modifications of the ribose-phosphate backbone may be done to increase the stability of the molecules; for example, PNA:DNA hybrids can exhibit higher stability in some environments.

“Primer” means an oligonucleotide, either natural or synthetic, that is capable, upon forming a duplex with a polynucleotide template, of acting as a point of initiation of nucleic acid synthesis and being extended from its 3′ end along the template so that an extended duplex is formed. The sequence of nucleotides added during the extension process is determined by the sequence of the template polynucleotide. Primers usually are extended by a DNA polymerase.

The term “research tool” as used herein refers to any composition or assay of the invention used for scientific enquiry, academic or commercial in nature, including the development of pharmaceutical and/or biological therapeutics. The research tools of the invention are not intended to be therapeutic or to be subject to regulatory approval; rather, the research tools of the invention are intended to facilitate research and aid in such development activities, including any activities performed with the intention to produce information to support a regulatory submission.

The term “selectively binds”, “selective binding” and the like as used herein, when referring to a binding agent (e.g., protein, nucleic acid, antibody, etc.), refers to a binding reaction between two or more binding agents with high affinity and/or complementarily. Typically, specific binding will be at least three times the standard deviation of the background signal. Thus, under appropriate designated assay conditions, a binding agent will bind one or more “target” agents and not bind in a significant amount to other molecules present in an assay.

“Sequencing”, “sequence determination” and the like means determination of information relating to the nucleotide base sequence of a nucleic acid. Such information may include the identification or determination of partial as well as full sequence information of the nucleic acid. The sequence information may be determined with varying degrees of statistical reliability or confidence. In one aspect, the term includes the determination of the identity and ordering of a plurality of contiguous nucleotides in a nucleic acid. “High throughput digital sequencing” or “next generation sequencing” means sequence determination using methods that determine many (typically thousands to billions) of nucleic acid sequences in an intrinsically parallel manner, i.e. where DNA templates are prepared for sequencing not one at a time, but in a bulk process, and where many sequences are read out preferably in parallel, or alternatively using an ultra-high throughput serial process that itself may be parallelized. Such methods include but are not limited to pyrosequencing (for example, as commercialized by 454 Life Sciences, Inc., Branford, Conn.); sequencing by ligation (for example, as commercialized in the SOLiD™ technology, Life Technology, Inc., Carlsbad, Calif.); sequencing by synthesis using modified nucleotides (such as commercialized in TruSeq™ and HiSeq™ technology by Illumina, Inc., San Diego, Calif., HeliScope™ by Helicos Biosciences Corporation, Cambridge, Mass., and PacBio RS by Pacific Biosciences of California, Inc., Menlo Park, Calif.), sequencing by ion detection technologies (Ion Torrent, Inc., South San Francisco, Calif.); sequencing of DNA nanoballs (Complete Genomics, Inc., Mountain View, Calif.); nanopore-based sequencing technologies (for example, as developed by Oxford Nanopore Technologies, LTD, Oxford, UK), and like highly parallelized sequencing methods.

The term “Tₘ” is used in reference to the “melting temperature.” The melting temperature is the temperature at which a population of double-stranded nucleic acid molecules becomes half dissociated into single strands. Several equations for calculating the Tₘ of nucleic acids are well known in the art. As indicated by standard references, a simple estimate of the Tₘ value may be calculated by the equation, Tₘ=81.5+0.41 (% G+C), when a nucleic acid is in aqueous solution at 1 M NaCl (see, e.g., Anderson and Young, Quantitative Filter Hybridization, in Nucleic Acid Hybridization (1985)). Other references (e.g., Allawi, and SantaLucia, Jr., Biochemistry 36:10581-94 (1997)) include alternative methods of computation which take structural and environmental, as well as sequence characteristics into account for the calculation of Tₘ.

### DETAILED DESCRIPTION OF THE INVENTION

The practice of the techniques described herein may employ, unless otherwise indicated, conventional techniques and descriptions of organic chemistry, polymer technology, molecular biology (including recombinant techniques), cell biology, biochemistry, and sequencing technology, which are within the skill of those who practice in the art. Such conventional techniques include polymer array synthesis, hybridization and ligation of polynucleotides, and detection of hybridization using a label. Specific illustrations of suitable techniques can be had by reference to the examples herein. However, other equivalent conventional procedures can, of course, also be used. Such conventional techniques and descriptions can be found in standard laboratory manuals such as Green, et al., Eds., Genome Analysis: A Laboratory Manual Series (Vols. I-IV) (1999); Weiner, et al., Eds., Genetic Variation: A Laboratory Manual (2007); Dieffenbach and Dveksler, Eds., PCR Primer: A Laboratory Manual (2003); Bowtell and Sambrook, DNA Microarrays: A Molecular Cloning Manual (2003); Mount, Bioinformatics: Sequence and Genome Analysis (2004); Sambrook and Russell, Condensed Protocols from Molecular Cloning: A Laboratory Manual (2006); and Sambrook and Russell, Molecular Cloning: A Laboratory Manual (2002) (all from Cold Spring Harbor Laboratory Press); Stryer, Biochemistry, 4th Ed., (1995), W. H. Freeman, New York N.Y.; Gait, “Oligonucleotide Synthesis: A Practical Approach” (1984), IRL Press, London; Nelson and Cox, Lehninger, Principles of Biochemistry, 3^{rd} Ed., (2000), W. H. Freeman Pub., New York, N.Y.; and Berg et al., Biochemistry, 5^{th} Ed., (2002), W. H. Freeman Pub., New York, N.Y., all of which are herein incorporated in their entirety by reference for all purposes.

Note that as used herein and in the appended claims, the singular forms “a,” “an,” and “the” include plural referents unless the context clearly dictates otherwise. Thus, for example, reference to “a nucleic acid” refers to one or more nucleic acids, and reference to “the assay” includes reference to equivalent steps and methods known to those skilled in the art, and so forth.

Unless defined otherwise, all technical and scientific terms used herein have the same meaning as commonly understood by one of ordinary skill in the art to which this invention belongs. All publications mentioned herein are incorporated by reference for the purpose of describing and disclosing devices, formulations and methodologies that may be used in connection with the presently described invention.

Where a range of values is provided, it is understood that each intervening value, between the upper and lower limit of that range and any other stated or intervening value in that stated range is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either both of those included limits are also included in the invention.

In the following description, numerous specific details are set forth to provide a more thorough understanding of the present invention. However, it will be apparent to one of skill in the art that the present invention may be practiced without one or more of these specific details. In other instances, well-known features and procedures well known to those skilled in the art have not been described in order to avoid obscuring the invention.

### The Invention in General

In the assays of the invention, a first set of binding constructs comprising binding agents is associated with a support surface, e.g., immobilized on the support surface or provided in a discrete feature on the support surface. A second set of binding constructs also comprising binding agents is delivered to the support surface to test for binding interactions between the first set of binding agents and the second set of binding agents. Most typically, the second set of binding constructs is provided in solution to the first set of binding constructs on the support surface.

Following selective binding of the first and second binding agents, the first and second unique nucleic acid tags identifying each binding agent are co-localized. Once co-localized, the first and second unique nucleic acid tags may be coupled or associated with one another. Coupling can be achieved using a variety of mechanisms; preferably, the unique nucleic acid tags are coupled by copying or combining into a single molecule sequence information from both unique nucleic acid tags via a ligation or primer extension reaction. Coupling the two unique nucleic acid tags creates a binding event identifier that can be used to identify the first and second binding agents that formed a binding pair.

Thus, this Co-localized Affiity (COLA) assay is a multiplexed format that can detect individual single-molecule interactions (binding events) by making use of two sets of binding constructs comprising binding agents and unique nucleic acid tags, where at least one of the sets of binding constructs is anchored to a solid support and the other set of binding constructs is in solution. If a binding event occurs between the binding agents of these sets of binding constructs—either directly or via a third binding agent or analyte—the unique nucleic acid tags associated with the binding agents become co-localized, enabling the sequence information contained in the unique nucleic acid tags to be associated or coupled. The multiplexed format allows assays where either or both of the first and second set of binding constructs may comprise ten or more different binding agents, twenty or more different binding agents, twenty-five or more different binding agents, thirty-five or more different binding agents, fifty or more different binding agents, seventy-five or more different binding agents, 100 or more different binding agents, 500, 750, 1,000, 5,000, 10,000, 50,000, 100,000, 500,000, 1,000,000, or more different binding agents,

Through the creation of binding event identifiers, the assays of the invention are designed to provide very sensitive detection, wide dynamic range, and, uniquely, a greatly improved ability to carry out and analyze multiplexed assays involving all types of biological molecules. Moreover, using nucleic acid sequences as a proxy for molecular interaction events between biological molecules other than nucleic acids allows for more complex molecular interactions to be detected and reported by various means, such as mass spectroscopy, hybridization to a microarray, or in preferred embodiments, sequencing, and in more preferred embodiments, high throughput digital sequencing. For example, the assays of the invention provide high sensitivity protein assays that can be multiplexed much more easily and to much higher levels than traditional protein or peptide assays. The multiplexing of more than several immunoasssays is a very challenging problem and no current technologies serve this need effectively. COLA assays can be used in place of conventional protein binding assays such as ELISAs or proximity ligation (see, e.g., Fredriksson, et al., Nature Biotechnology, 20:473-77 (2002); and Fredriksson, et al., Nature Methods 4(4):327-29 (2007)); or proximity probes (see, e.g., U.S. Pat. Nos. 6,878,515 and 7,306,904 to Landegren) to allow multiplexing of hundreds or thousands of immunoasssays. Therefore, COLA assays have the potential to impact positively many areas of basic research, clinical diagnostics, and drug development. In some embodiments, at least 1,000 binding event identifiers are sequenced in parallel. In yet other embodiments, at least 10,000 binding event identifiers are sequenced in parallel. In yet other embodiments, at least 100,000, 500,000, 1,000,000, 10,000,000, 100,000,000, 1,000,000,000 or more binding event identifiers are sequenced in parallel.

In addition, by utilizing a set of binding constructs anchored to a support surface, the invention allows use of a high concentration of binding constructs in solution while still detecting single molecule events. Assays carried out primarily in solution generally require the use of lower concentrations of at least one set of binding agents to minimize binding between binding agents of the same set. In the assays of the present invention, non-bound binding agents provided in solution are preferably removed prior to identification of co-localized unique nucleic acid tags, optimizing detection only of binding events between first and second binding agents. The use of higher concentrations of binding agents combined with the ability to detect large numbers of binding pairs through the creation of binding event identifiers allows analysis of greater numbers of binding agents.

In addition, the invention provides a direct mechanism for identifying and discounting false positives by examining the combinations of unique nucleic acid tags found in the binding event identifier. It is a unique feature of the invention that a true positive signal from a binding event identifier identifying a specific binding pair must contain the unique nucleic acid tags associated with each binding agent of the binding pair, and false positives containing incompatible combinations of unique nucleic acid tags in a binding event identifier can be directly identified. For example, combinations of unique nucleic acid tags from the same set of binding constructs can be identified as being caused from intra-set binding, and the results discarded as false positives. In yet another example, when first and second binding agents from the first and second sets of binding constructs are known, such as when used in a sandwich assay (ELISA), and are known to bind a third agent, the unique nucleic acid tags of the binding pair are known; thus, any binding event identifiers that contain faulty pairings of unique nucleic acid tags can be identified as a false positive and subtracted from the resulting data, which provides an enormous advantage in multiplexed assays. Another feature of the invention allows for identification of binding agents that bind promiscuously. Promiscuous binding agents, once identified, can be subtracted from the resulting data and/or a quantitative metric can be derived for the extent of promiscuity and the data treated accordingly. Moreover, because the first set of binding constructs of the assays are secured to a support surface, no additional sorting of the binding event identifiers is required to distinguish true positive signals from false positives, contrary to assays that are performed in solution.

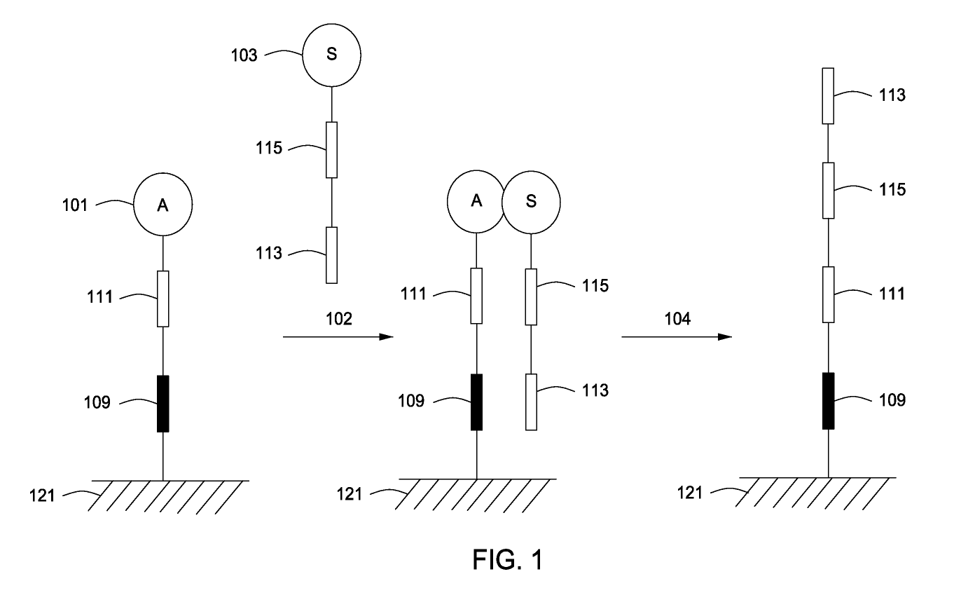

A general assay scheme of the invention is illustrated in FIG. 1. The assay identifies interactions between members of a first set of binding constructs comprising first binding agents that are associated or “anchored” to a support surface 121 (shown here as a single binding construct having binding agent “A” 101) and a second set of binding constructs comprising second binding agents that are provided in the assay in solution (shown here as a single binding agent “S” 103). Each binding construct will preferably comprise only one binding agent; however, binding constructs in the first and/or second set generally have different binding agents, and in some embodiments, the first and/or second sets may comprise hundreds or thousands of different binding agents. In this simplified assay scheme; however, only a single first binding construct and a single second binding construct is shown.

The first binding construct comprises first binding agent 101 associated with a first primer region 109 and a first unique nucleic acid tag 111. The second binding construct comprises second binding agent 103, a second primer region 113, and a second unique nucleic acid tag 115. The second binding construct is added at step 102 to the surface-bound first binding construct and when first binding agent 101 and second binding agent 103 bind, first and second unique nucleic acid tags 111 and 115 are co-localized. Co-localized first and second unique nucleic acid tags can be coupled (generally by copying or combining into a single molecule the sequence information from both unique nucleic acid tags) as shown in step 104 by, e.g., ligation or primer extension, as described in more detail herein.

In this example, the product of the coupling (the binding event identifier) comprises primer region 109, unique nucleic acid tags 111 and 115, and primer region 113. The binding event identifier can be amplified using primer regions 109 and 113. Determination of the sequence of the binding event identifier, e.g., through nucleic acid sequencing using the primer regions 109 and/or 113 or by mass spectroscopy, identifies the binding event between the first binding agent 101 and second binding agent 103. In some aspects, the end of primer region 113 is blocked to prevent interactions with the nucleic acid regions associated with binding agent 101, preventing the occurrence of spurious unique nucleic acid tag associations or couplings that do not accurately reflect a true binding event.

### Binding Constructs and Methods of Construction Thereof

The set of binding constructs associated with the support surface can comprise any binding agents, including DNA/RNA aptamers, peptides, proteins, small molecule drug candidates, carbohydrates, or other molecules. In one specific aspect, the binding agents of the first set are peptide-based molecules that are the encoded by the nucleic acid sequences within the binding construct, e.g., the unique nucleic acid tags—that is, the unique nucleic acid tags code for the peptide binding agent, as well as uniquely identify the peptide binding agent. In preferred aspects, the supports having immobilized binding constructs and methods of constructing such supports include those disclosed in co-pending application PCT/US10/59327, filed Dec. 7, 2010, entitled “Peptide Display Arrays”, which is incorporated herein by reference.

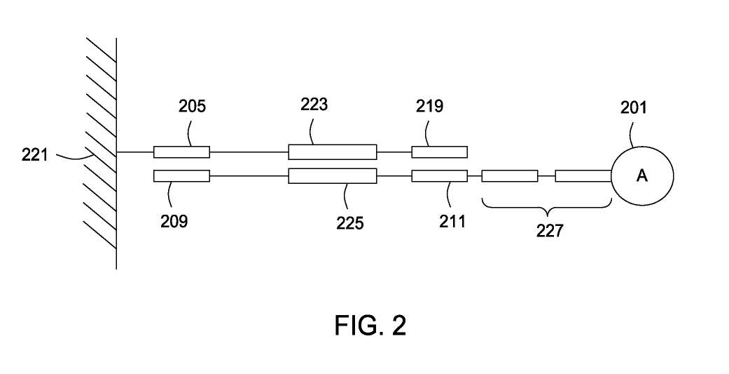

FIG. 2 illustrates an immobilized binding construct comprising binding agent A 201. In FIG. 2, the binding construct comprises two components: an anchor oligonucleotide and a binding oligonucleotide. In FIG. 2, anchor oligonucleotide anchored to solid support 221 comprises an anchor 205, a unique nucleic acid tag 223, and region 219. This anchor oligonucleotide is hybridized to a binding oligonucleotide comprising primer region 209, complementary to anchor 205; region 225 complementary to unique nucleic acid tag 223, and a region 211 complementary to 219. Region 211 is attached to the binding agent 201 of the binding oligonucleotide via region 227 which may comprise an additional primer binding region and/or amplification region and a second unique nucleic acid region (that may, e.g., encode the binding agent 201). A comparison of FIG. 1 and FIG. 2 demonstrates that the first set of binding constructs secured to the support surface can be single-stranded, as shown in FIG. 1, or double-stranded, as shown in FIG. 2.

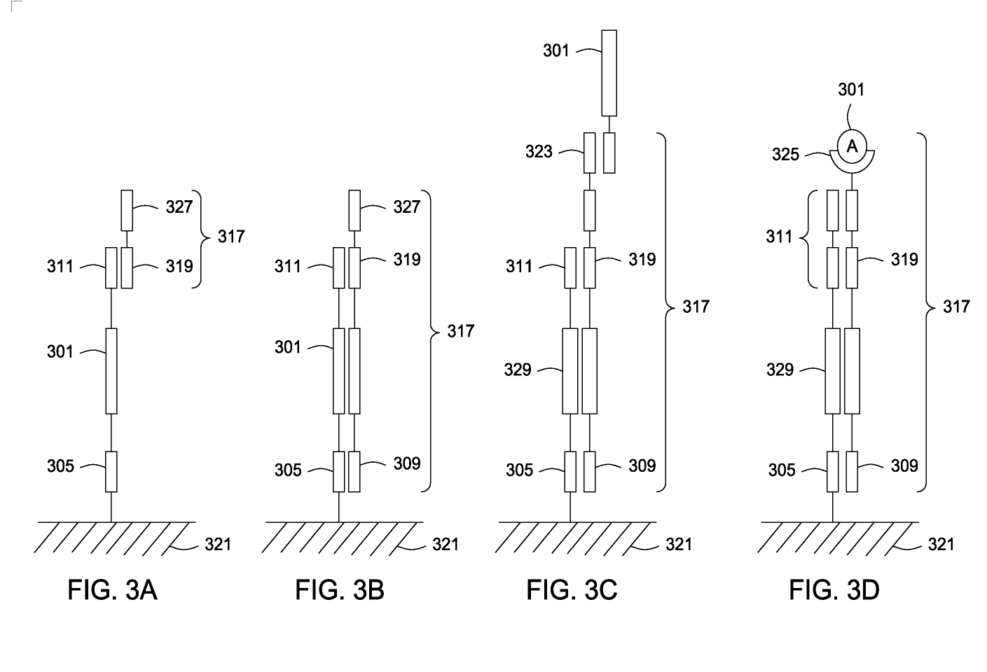

FIGS. 3A through 3D illustrate other exemplary binding constructs that can be associated with the support surface. The binding agents of the exemplary set of binding agents in FIGS. 3A through 3D thus may be DNA, RNA, or proteins or peptides, and may be produced using nucleic acid portions of the binding constructs (i.e., by transcription and/or translation) that are part of the binding construct. The binding constructs can comprise, for example, binding agents 301 that are a custom set of single-stranded DNAs (as illustrated in FIG. 3A); double-stranded DNAs (as illustrated in FIG. 3B); RNAs that are encoded by the binding constructs and attached via hybridization after an in vitro transcription reaction (as illustrated in FIG. 3C); or peptides or proteins that are encoded by the binding constructs and coupled via affinity capture after in vitro transcription and translation reactions (as illustrated in FIG. 3D) (see, e.g., U.S. Pat. No. 6,416,950 to Lohse; and Kurz, et al., Chembiochem, 2:666-672 (2001), both of which are incorporated herein in their entirety). Each of these binding constructs is immobilized via an anchor 305 bound to a support surface 321. The binding constructs each comprise a binding agent 301, which can be coupled either directly (as in FIGS. 3A and 3B), or indirectly to anchor 305 via binding oligonucleotide 317. Note the use and composition of oligonucleotide 317 varies in schemes 3A, 3B, 3C and 3D.

In FIG. 3A oligonucleotide 317 comprises a unique nucleic acid tag 319 complementary to a region 311 on the anchor oligonucleotide and a region 327 at its 5′-end used in various assay schemes to couple the unique nucleic acid tags of the first and second binding agents. In FIG. 3A, the binding agent 301 is an anchored, single-stranded DNA that can interact with a binding agent the second set of binding constructs (not shown), and oligonucleotide 317 can be used to couple the unique nucleic acid tags from the first set of binding constructs and the unique nucleic acid tags from the second set of binding constructs together.

In FIG. 3B, oligonucleotide 317 consists of a region 309 complementary to anchor 305; a region of first binding agent 301; a unique nucleic acid tag 319; and a region 327 at the 5′-end used in various assay schemes to couple the unique nucleic acid tags of the first set of binding constructs to the unique nucleic acid tags of the second set of binding constructs. In this example, binding agent 301 is an anchored, double-stranded DNA that may interact with a binding agent from the second set of binding constructs (not shown), and oligonucleotide 317 will be used to couple the unique nucleic acid tags from the first and second set of binding constructs together.

In FIG. 3C, oligonucleotide 317 is very similar to scheme 3B except in scheme 3C, oligonucleotide 317 comprises an additional region 323 at the 5′-end used to couple the binding agent of the first binding construct to the anchor oligonucleotide via hybridization (i.e., the first binding construct in this embodiment comprises three oligonucleotides). In this embodiment, region 329 codes for, e.g., RNA. After in vitro transcription of region 329, the RNA transcript 301 is captured by hybridization between region 323 located at the 5′-end of oligonucleotide 317 and the complementary sequence on the RNA transcript. Capture of RNA binding agent 301 allows it to interact with a second binding agent of the second set of binding constructs (not shown), and oligonucleotide 317 can be used to couple the unique nucleic acid tags from the first and second sets of binding constructs together.

In FIG. 3D, oligonucleotide 317 is very similar to oligonucleotides 317 in schemes 3B and 3C, except oligonucleotide 317 in FIG. 3D has a capture agent 325 associated with it. In scheme 3D, region 329 codes for a peptide. After in vitro transcription and translation, the translated peptide binding agents 301 are captured at the 5′-end of oligonucleotide 317 via capture agent 325. Binding agents 301 can then interact with a binding agent from the second set of binding constructs (not shown), and oligonucleotide 317 can be used to couple the unique nucleic acid tags from the first and second sets of binding constructs together. Methods for transcription, translation and peptide capture using a capture agent are disclosed in U.S. Pat. No. 6,416,950 to Lohse and Kurz, et al., Chembiochem, 2:666-672 (2001), both of which are incorporated herein in their entirety).

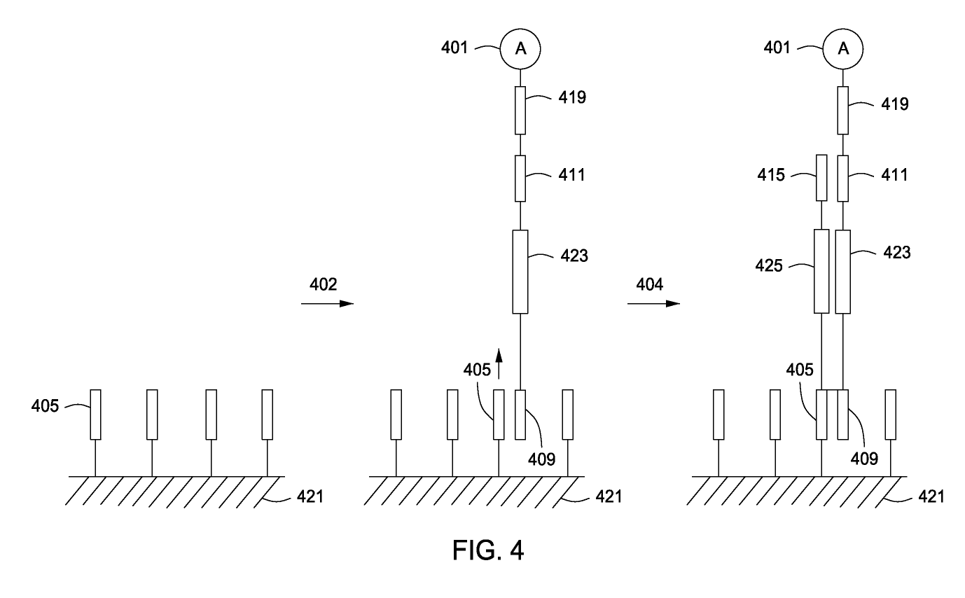

Various methods can be used to produce surface-bound constructs comprising the first set of binding constructs such as the exemplary binding constructs shown in FIGS. 3A through 3D. Exemplary methods for constructing the first set of binding constructs on solid supports are illustrated in FIGS. 4 through 6.

In FIG. 4, a support surface 421 comprising multiple anchors 405 are used to couple the first set of binding constructs to the support surface 421. Briefly, the first set of binding constructs comprise first binding agent 401; region 419, which may optionally encode the binding agent 401; unique nucleic acid tag 411; region 423 used in reactions to couple the unique nucleic acid tags of the first and second sets to form the binding event identifier; and region 409 complementary to anchor 405. The first binding constructs are diluted and hybridized in step 402 to anchor 405 on the surface 421 of, e.g., a flowcell or a bead. Hybridization optionally is followed by a primer extension reaction in step 404 using an appropriate polymerase that extends anchor 405 to include regions 425 complementary to regions 423, and 415 complementary to unique nucleic acid tag 411. Here, a moiety between regions 411 and 419 is included in the first binding construct to prevent the polymerase extending past region 411.

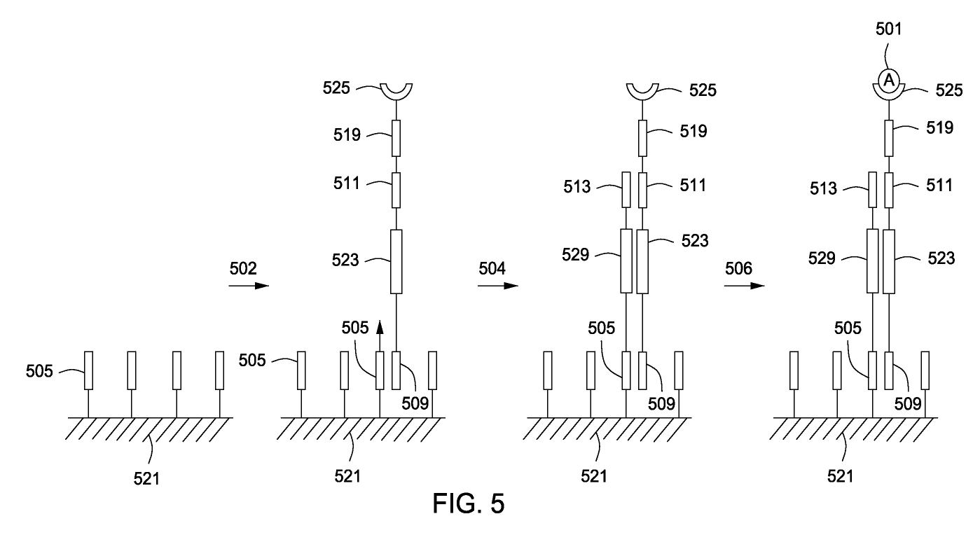

In FIG. 5, a support surface 521 comprising multiple anchors 505 is used to couple the binding constructs to the support surface 521. The first set of binding constructs, comprising capture agent 525, unique nucleic acid tag 519, a primer region 511, region 523 and region 509 complementary to anchor 505, are diluted and hybridized in step 502 to the anchor 505 on the surface 521, e.g., of a flowcell or a bead. Primer extension is performed at step 504 using an appropriate polymerase. In the resulting duplex binding construct, region 523/529 encodes for peptide binding agent 501. After in vitro transcription and translation, peptide binding agent 501 is captured via affinity capture agent 525.

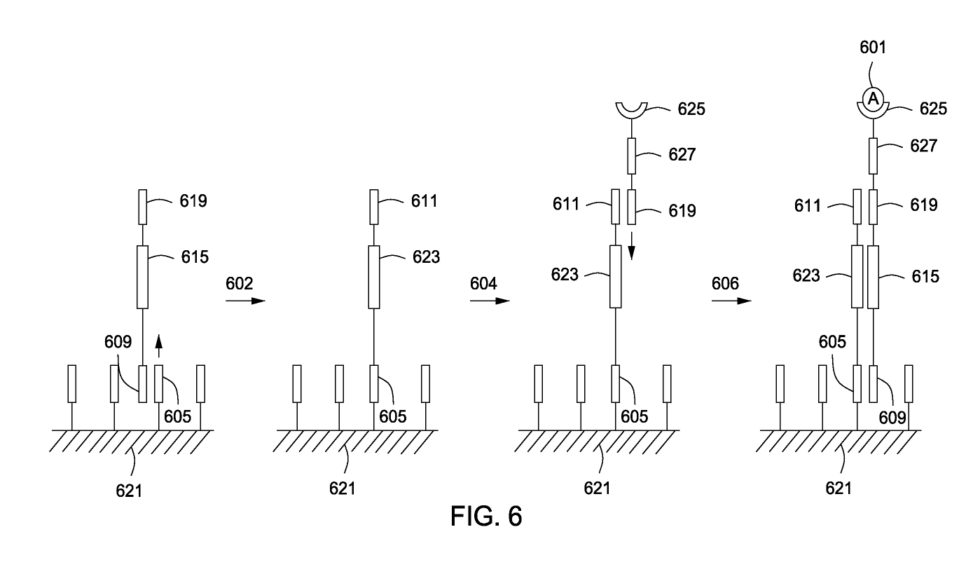

FIG. 6 is a variation of the method of FIG. 5. A first oligonucleotide comprising a primer 619, region 615 and region 609 complementary to anchor 605 is hybridized to anchor 605. Primer extension is used to extend anchor 605. The first oligonucleotide that is not attached to surface 621 is removed (e.g., by denaturation), leaving the product of the primer extension (comprising anchor 605, coding region 623 complementary to region 615, and a region 611 complementary to unique nucleic acid tag 619) immobilized on surface 621. A second oligonucleotide comprising capture agent 625, region 627 and unique nucleic acid tag 619 is then hybridized to the immobilized primer extension product to produce the first set of binding constructs. A second primer extension reaction is performed, extending the second oligonucleotide to include region 615, the complement of 623 that encodes peptide binding agent 601, and region 609, complementary to anchor 605. In this first set of binding constructs, region 623 encodes peptide binding agent 601. After in vitro transcription of region 623 and translation of the resulting RNA, the peptide (binding agent) 601 is captured via capture agent 625.

Thus, as illustrated in FIGS. 5 and 6, transcription and translation reactions can be used to produce peptides encoded by DNA sequences that are part of the first set of binding constructs, and the first set of binding constructs are then used to capture the translated peptides. This process leads to formation of an array of peptides or proteins attached to their own templates (again, see U.S. Pat. No. 6,416,950 to Lohse and Kurz, et al., Chembiochem, 2:666-672 (2001), both of which are incorporated herein in their entirety).

In certain aspects, it may be desirable for the anchors 605 to be reversibly blocked to prevent spurious reactions that may occur via their active 3′ ends; for example, anchors 605 could hybridize non-specifically and be extended. If anchors 605 are blocked, after the binding step of the binding assay is performed anchors 605 could optionally be unblocked to participate, e.g., in amplification.

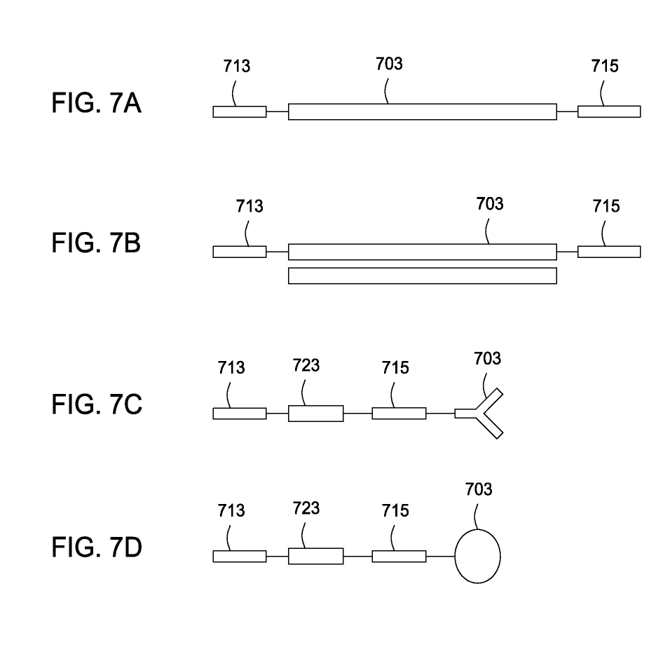

The second set of binding constructs that are used in the assays of the invention also comprise a unique nucleic acid identifier, a binding agent, and in some embodiments the second set of binding constructs comprise nucleic acids that encode a binding agent. Exemplary constructs that can be used in the second set of binding constructs are illustrated in FIGS. 7A through 7D. For example, binding constructs of the second set can comprise a custom set of single-stranded DNAs or RNAs as illustrated in the constructs at 7A, which comprise a single-stranded binding agent 703 that can also serve as the unique nucleic acid tag; common hybridization or priming region 715 to enable amplification and/or sequencing of the binding event identifier; and a region 713 to enable formation of the binding event identifier.

Alternatively, the second set of binding constructs may comprise double-stranded DNAs as illustrated in the constructs at 7B, which comprise a double-stranded binding agent 703 that can also serve as the unique nucleic acid tag; a common hybridization or priming region 715; and a region 713 that enables formation of the binding event identifier.

In yet another configuration as illustrated in the constructs at 7C, the second set of binding constructs may comprise antibodies 703; a unique nucleic acid tag 715; a hybridization or priming region 723; and a region 713 that enables formation of the binding event identifier. In yet another configuration, the second set of binding constructs may comprise peptides, small molecules (including drug candidates), carbohydrates, peptides or proteins as illustrated in the constructs at 7D. The binding constructs at 7D comprise a binding agent 703, a unique nucleic acid tag 715, hybridization or priming region 723, and region 713 that enables formation of the binding event identifier. When binding agent 703 is a peptide or protein, it may comprise all or a portion of a binding region of that peptide or protein, and in some embodiments, the unique nucleic acid tag 715 encodes the peptide or protein binding agent. Hybridization or priming region 723, as in other exemplary binding constructs, is used for purposes of amplification and/or initiating sequencing reactions.

The binding agents 703 of the second set of binding constructs can be attached to the second set of binding constructs at the 5′ end, the 3′end, or to a different portion of the construct (e.g., via a linker which is optionally cleavable). In assays based on primer extension, the binding agents of the second set of binding constructs are generally attached to the 5′ end of the binding constructs, and the 3′ end of the binding construct is blocked (e.g., using a dideoxynucleotide). However, placement of the binding agent in the second set of binding constructs will vary depending on the mechanics of the assay, as can be determined by one skilled in the art.

### Binding Agent Interactions

The assay schemes of the invention are useful in identifying multiple types of binding agent interactions. The following figures illustrate the interactions of the binding agents of the assays.

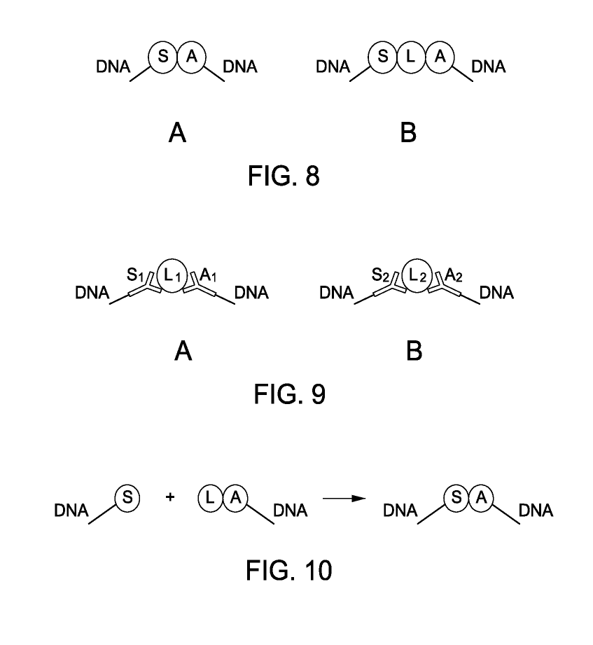

In many of the described assay schemes of the invention, binding agents of the first and second binding constructs are being analyzed for their ability to bind directly to one another. An example of this type of direct binding between first and second binding agents is illustrated in FIG. 8 at 8A, where the binding agent of the first set of binding constructs (A) binds directly to the binding agent of the second set of binding constructs (S). In certain other assay schemes of the invention, however, the first and second binding agents may be analyzed for their ability to bind a third agent or analyte in addition to or in place of binding to one another. For example, as illustrated in FIG. 8 at 8B, the binding agent of the first set of binding constructs (A) and the binding agent of the second set of binding constructs provided in solution (S) bind to a third agent or analyte (L) and do not bind directly to one another.

FIG. 9 illustrates a specific aspect of the binding interactions illustrated at in FIG. 8B. In FIG. 9, the first and second binding agents (binding pair) are provided as antibodies or variable domains of antibodies that bind to different epitopes on a common molecule. The presence and binding of both the first (A) and second (S) binding agents is necessary for the detection of the third molecule. In this case, S1 and A1 are specific for binding L1, and S2 and A2 are specific for binding L2.

In yet other assays of the invention, the binding pairs are tested for binding affinity to one another via the ability to displace the binding of a third agent or analyte bound to one of the first or second binding agents. FIG. 10 illustrates one possible binding displacement assay using the first and second binding agents. The ability of the binding agents of the second set of binding constructs (S) to disturb binding of third agent (L) to binding agents of the first, anchored set of binding constructs (A) may be tested. In one example, the second set of binding constructs comprises binding agents (S), which may be a set of small molecule drug candidates that are being tested for the ability to interfere with the binding of first and third binding agents (A) and (L). In another example, binding agents (S) can be a set of one or more molecules related to (L), but with variations. Binding agents (S) with variations are tested for their ability to displace third binding agent (L); that is, second binding agents (S) are screened to see if they have more affinity to first binding agent (A) than third binding agent (L). Such an assay is extremely useful for optimization of chemical moieties, e.g., small molecules with different chemical functional groups, antibodies with various functional groups and the like.

### Specific Assays of the Invention

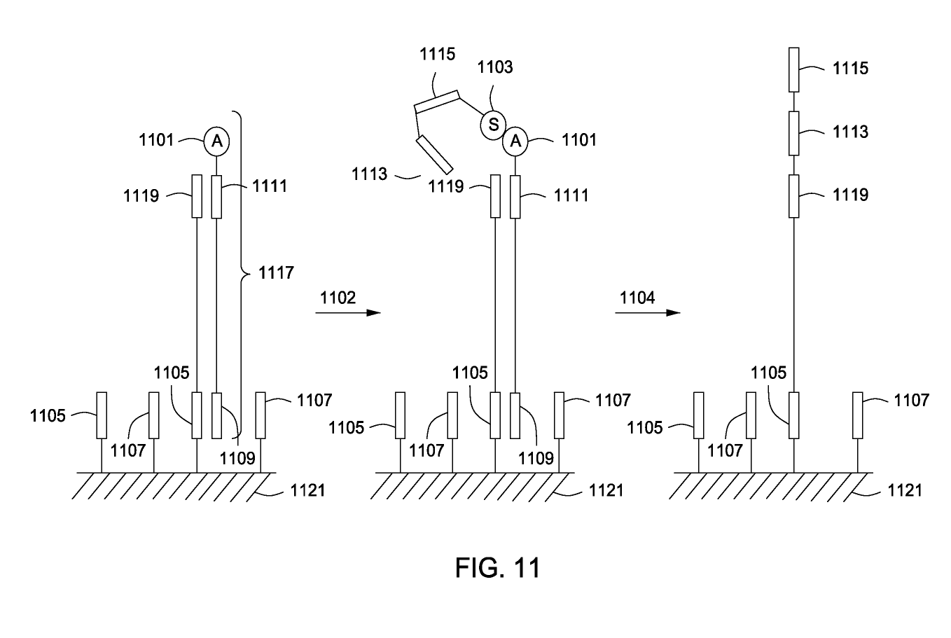

One specific assay scheme is shown in FIG. 11. This figure illustrates an assay according to the present invention where nucleic acid sequencing of a binding event identifier is used to determine whether binding of binding agents from the first and second sets of binding constructs took place. This assay utilizes an anchored first set of binding constructs, a second set of binding constructs in solution, and ligation to create the binding event identifier.

Members of first binding construct set are immobilized on a surface 1121 so that each molecule is well spaced from another. For example, the first set of binding constructs 1117 may hybridize to anchor 1105 on surface 1121, e.g., the surface of a flowcell or a microbead, but may not hybridize to anchors 1107. Once hybridized, anchor 1105 may be extended so that it will include unique nucleic acid tag 1119 (a complement of region 1111). Alternatively, in other embodiments, an additional oligonucleotide comprising region 1119 could be hybridized to first binding constructs 1117 and ligated to anchor 1105. Binding oligonucleotide 1117 of first binding construct comprises a nucleic acid region 1109 complementary to anchor 1105 and a region 1111 that is complementary to the unique nucleic acid identifier 1119 that identifies first binding agent 1101. The first set of binding constructs is exposed in step 1102 to a second set of binding constructs in solution. The second set of binding constructs comprises unique nucleic acid tag 1113, primer region 1115, and second binding agent 1103.

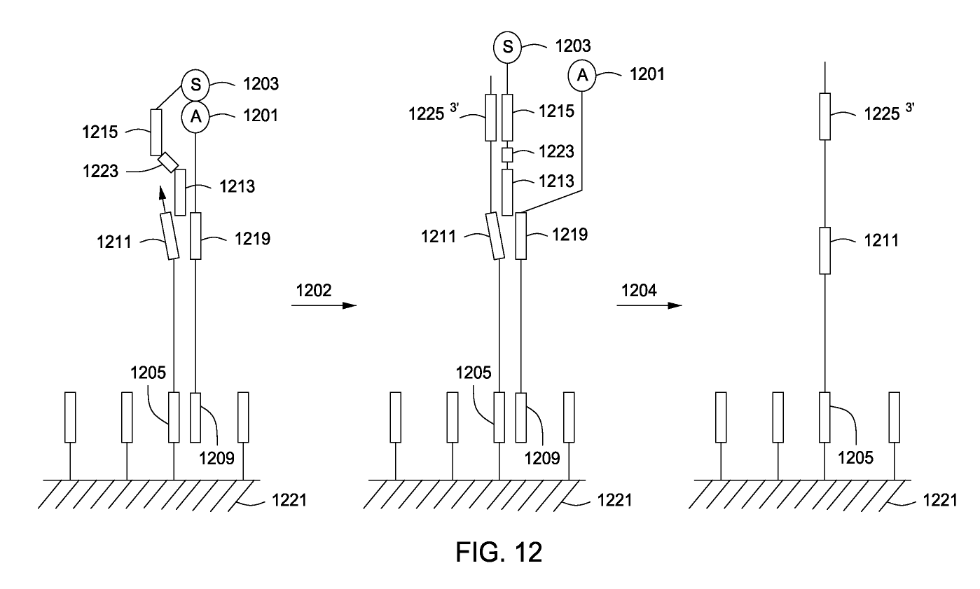

If binding takes place between binding agents 1101 and 1103, the free end of unique nucleic acid tag 1113, associated with binding agent 1103, will be co-localized with unique nucleic acid tag 1119, associated with binding agent 1101. Molecular interaction between the two unique nucleic acid tags 1113 and 1119 enables them to be coupled at step 1104 by performing ligation. (see, e.g., Fredriksson, et al., Nature Biotechnology, 20:473-77 (2002); Fredriksson, et al., Nature Methods 4(4):327-29 (2007); Gustafsdottir, et al., Anal Biochem 245:2-9 (2004), all of which are incorporated in their entirety herein for all purposes). Alternatively, unique nucleic acid tags 1113 and 1119 may be coupled by primer extension where 1119 is complementary to 1113 in all or in part (i.e., 1113 is similar to or the same as 1111) and there is displacement of the 1119/1111 duplex and extension (as depicted in the embodiment in FIG. 12). Once the two unique nucleic acid tags are coupled, they can be amplified using primers complementary to regions 1105 and 1107 and sequenced.

In FIG. 11, amplification can be performed, e.g., by Genome Analyzer technology (Illumina, Inc., San Diego, Calif.), where region 1115 hybridizes to anchors 1107 and anchors 1107 are extended by a polymerase to form a double-stranded molecule with each strand anchored via either 1105 or 1107 to surface 1121 of the substrate at opposite ends. Successive rounds of denaturation, hybridization to new primers 1105 and 1107 on surface 1121, and extension grows a cluster of molecules that can then be sequenced on one strand or in both directions. Alternatively, the binding constructs of the invention can be amplified and sequenced by other means, e.g., on a bead surface (as used in the SOLiD™ and 454 platforms) using emulsion PCR, in which case anchor 1107 would not be provided on surface 1121. In such methods, beads ideally comprise a single binding construct. In yet other embodiments, direct single molecule approaches such as True Single Molecule Sequencing (tSMS)™ technology by Helicos Biosciences Corp. (Cambridge, Mass.), amplification is omitted. Thus, although FIG. 11 is illustrated with two different anchors (1105, 1107) on surface 1121, it will be apparent to one skilled in the art upon reading the specification that the configuration of anchors on the support surface should be designed for the specific sequencing technology employed. Additionally, entire binding constructs can be sequenced or, with appropriate primers, only the two unique nucleic acid tags (the binding event identifier) can be sequenced. The sequence information obtained from coupled first and second unique nucleic acid tags 1119 and 1113, respectively (collectively, the binding event identifier), provides information about the nature of interacting first and second binding agents of the first and second binding construct sets.

FIG. 12 illustrates a binding detection assay that utilizes strand displacement and polymerization to couple the unique nucleic acid tags of the first and second binding constructs (see, e.g., Walker, et al, Nucleic Acid Res., 20:1691 (1992); Walker, et al., Nucleic Acid Res., 24:348-53 (1996); and Benoit, et al, Protein Expr Purif, 45:66-71 (2006), all of which are incorporated herein in their entirety for all purposes). Surface 1221 comprises a set of binding constructs anchored with anchor oligonucleotides wherein the anchor oligonucleotides comprise one or more primers. The anchor oligonucleotides in this exemplary figure comprise anchor 1205 (which may also serve as a primer) and primer 1211. Anchor oligonucleotides are coupled or secured to a surface 1221, e.g., of a flowcell or a bead. The binding oligonucleotide is attached to surface 1221 by hybridization to the anchor oligonucleotide and comprises region 1209 complementary to anchor 1205 of the anchor oligonucleotide. The binding oligonucleotide further comprises region 1219, and first binding agent 1201 (A). In this embodiment, the combination of the binding oligonucleotide and the anchor oligonucleotide forms the first binding construct.

It should be recognized by one skilled in the art that the anchor oligonucleotides and first binding constructs can be added and constructed in a variety of ways. Here, the anchor oligonucleotide comprises anchor 1205 and 1211; however, initially the anchor oligonucleotide may comprise 1205 only, which is then hybridized to the first binding construct, and extended to include region 1211. In yet another alternative, an additional oligonucleotide comprising region 1211 could be ligated to anchor 1205.

First binding constructs are exposed to a set of second binding constructs, comprising second binding agents 1203, the second unique nucleic acid tag 1223, and region 1213 having a blocked nucleic acid end where region 1213 comprises a template region for primer 1211 of the anchor oligonucleotide. When binding agents 1201 and 1203 bind, region 1213--which shares sequence identity at least in part with region 1219—of the second binding construct will compete with region 1219 attached to binding agent 1201 for hybridization to primer 1211 (displacement) and will extend the anchor oligonucleotide attached to the surface 1221 upon addition of a polymerase at step 1202. This leads to production of a nucleic acid comprising the anchor oligonucleotide and a portion of the second binding construct comprising binding agent 1203. The extended oligonucleotide comprises region 1225, which is complementary to 1215; region 1211, which is complementary to region 1219; and anchor 1205. The regions 1225 and 1205 flanking the binding event identifier (comprising unique nucleic acid tags 1211 and 1227) may be used as primer sites for amplification and/or sequencing.

In some aspects, the use of a sequence-specific primer adds an additional level of specificity. In a single-molecule only embodiment of the assay, the interaction between first and second binding agents is stabilized (e.g., by chemical or photochemical cross-linking) and the two unique nucleic acid tags are sequenced independently, with no attempt made to couple the unique nucleic acid tags directly. Instead, spatial coincidence of signal is used to determine whether in fact an interaction is likely to have taken place. Such an embodiment removes constraints on the structure of the constructs, so that they can be relatively simple.

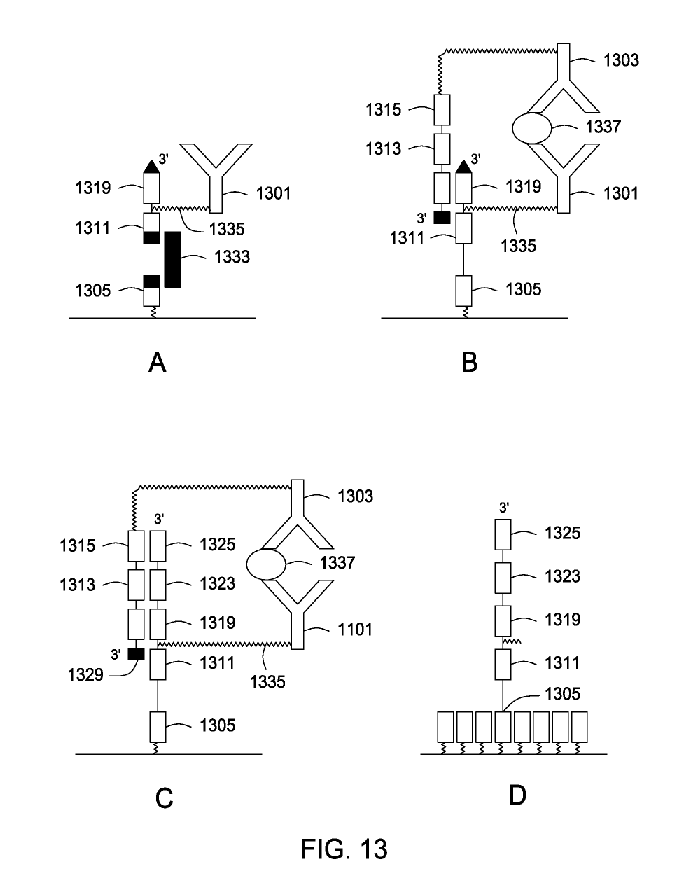

FIG. 13 illustrates yet another assay scheme for detection of an agent or analyte using two sets of binding constructs. At A, the first binding construct used in the assay is illustrated, where the binding construct is ligated using a splint sequence 1333 to a anchor 1305 attached to a solid support. An antibody 1301 is attached to a nucleic acid portion of the first binding construct via a cleavable linker 1335. The binding construct further comprises a unique nucleic acid tag 1319 that identifies the binding agent (in this case, an antibody). Sequence 1311 is a primer sequence. In B, a binding assay is carried out. In the first part of the assay, a target agent 1337 is captured. Binding of the binding agent 1303 of the second set of binding constructs to target agent 1337 may be done in solution prior to exposing the second set of binding constructs to the first set of binding constructs, or the second set of binding constructs comprising binding agents 1303 and target agent 1337 may be applied separately or simultaneously to the support surface (i.e., without a previous opportunity to interact).

Also in the second part of the assay at B, a second binding construct, blocked at the 3′ end 1329 (black square) so that it cannot be extended, is bound to the first binding construct via target agent 1337. The second binding construct comprises a unique nucleic acid tag 1313 that identifies the second binding agent present in the second binding construct and a primer/hybridization region 1315. In C, primer extension is carried out resulting in the first binding construct extended to comprise anchor 1305; primer 1311; first unique nucleic acid sequence tag 1319; second unique nucleic acid tag 1323, the complement to second unique nucleic acid tag 1313; and primer/hybridization region 1325, the complement to primer/hybridization region 1315. In 13D, the cleavable linker 1335 attaching the first binding agent 1301 to the first binding construct is cleaved, and washing removes the second binding construct, the first antibody 1301 and target agent 1337. The primer-extended construct attached to the support surface can now be assayed. For example, it can be amplified using either surface PCR or an emulsion PCR, followed by sequencing.

### Detection of Binding Event Identifiers

Numerous methods can be used to identify the binding event identifiers used in the assay systems of the invention. The binding event identifiers comprise a combination of two unique nucleic acid tags, one present on each of the binding constructs, and the association of these unique nucleic acid tags, e.g., through incorporation into a single oligonucleotide. This binding event identifier can be detected using techniques such as mass spectroscopy (e.g., Maldi-T of, LC-MS/MS), nuclear magnetic resonance imaging, or, in preferred embodiments, nucleic acid sequencing. Examples of techniques for measuring such binding event identifiers can be found, for example, in U.S. Appln. No. 20080220434, which is incorporated herein by reference. For example, the unique nucleic acid tags could be oligonucleotide mass tags (OMTs or massTags) that label each binding construct. Such tags are described, e.g., in U.S. Pat Appln. 20090305237, which is incorporated by reference in its entirety. In yet another alternative, the binding event identifiers could be amplified and hybridized to a microarray on which pairwise combinations of tags are represented as probes.

In one preferred aspect, binding event identifiers created from the assay method are substrates for next-generation sequencing, and highly parallel next-generation sequencing methods are used to confirm the sequence of the binding event identifiers, for example, with SOLiD™ technology (Life Technologies, Inc.) or Genome Analyzer (Illumina, Inc.). Such next generation sequencing methods can be carried out, for example, using a one pass sequencing method or using paired-end sequencing. Next generation sequencing methods include, but are not limited to, hybridization-based methods, such as disclosed in e.g., Drmanac, U.S. Pat. Nos. 6,864,052; 6,309,824; and 6,401,267; and Drmanac et al, U.S. patent publication 2005/0191656; sequencing-by-synthesis methods, e.g., U.S. Pat. Nos. 6,210,891; 6,828,100; 6,969,488; 6,897,023; 6,833,246; 6,911,345; 6,787,308; 7,297,518; 7,462,449 and 7,501,245; U.S. Publication Application Nos. 20110059436; 20040106110; 20030064398; and 20030022207; Ronaghi, et al, Science, 281: 363-365 (1998); and Li, et al, Proc. Natl. Acad. Sci., 100: 414-419 (2003); ligation-based methods, e.g., U.S. Pat. Nos. 5,912,148 and 6,130,073; and U.S. Pat. Pub. Nos. 20100105052, 20070207482 and 20090018024; nanopore sequencing e.g., U.S. Pat. Pub. Nos. 20070036511; 20080032301; 20080128627; 20090082212; and Soni and Meller, Clin Chem 53: 1996-2001 (2007)), as well as other methods, e.g., U.S. Pat. Pub. Nos. 20110033854; 20090264299; 20090155781; and 20090005252; also, see, McKernan, et al., Genome Res., 19:1527-41 (2009) and Bentley, et al., Nature 456:53-59 (2008), all of which are incorporated herein in their entirety for all purposes.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims. In the claims that follow, unless the term “means” is used, none of the features or elements recited therein should be construed as means-plus-function limitations pursuant to 35 U.S.C. §112, ¶6.

We claim:

1. A method for identifying binding agents that form a binding pair, comprising:
providing a first set of binding constructs immobilized on a support surface, wherein each binding construct of the first set of binding constructs comprises a first binding agent and a first nucleic acid tag unique to the first binding agent;
providing a second set of binding constructs in solution, wherein each binding construct of the second set of binding constructs comprises a second binding agent and a second nucleic acid tag unique to the second binding agent, and wherein either or both of the first and second sets of binding constructs comprises at least ten different binding agents;
combining the first and second sets of binding constructs under conditions to allow the first binding agents and the second binding agents to form binding pairs, thereby co-locating the first nucleic acid tags and the second nucleic acid tags;
creating binding event identifiers from the co-located first and second nucleic acid tags; and
determining a sequence of each binding event identifier; wherein the sequence of each binding event identifier identifies the binding pair and the binding agents that form the binding pair.

2. The method of claim 1, wherein the sequence of the binding event identifier is determined by digital readout.

3. The method of claim 2, wherein the sequence of the binding event identifier is determined by high throughput digital sequencing.

4. The method of claim 1, wherein either or both of the first and second sets of binding constructs comprises at least twenty-five different binding agents.

5. The method of claim 4, wherein either or both of the first and second sets of binding constructs comprises at least one hundred different binding agents.

6. The method of claim 5, wherein either or both of the first and second sets of binding constructs comprises at least one thousand different binding agents.

7. The method of claim 6, wherein either or both of the first and second sets of binding constructs comprises at least five thousand different binding agents.

8. The method of claim 1, wherein the sequences of the binding event identifiers are determined in parallel.

9. The method of claim 8, wherein the sequence of at least one thousand binding event identifiers are determined in parallel.

10. The method of claim 9, wherein the sequence of at least one hundred thousand binding event identifiers are determined in parallel.

11. The method of claim 1, wherein the binding event identifier is created by coupling the first and second nucleic acid tags.

12. The method of claim 10, wherein the coupling of the first and second tags is accomplished by ligation.

13. The method of claim 10, wherein the coupling of the first and second tags is accomplished by primer extension.

14. The method of claim 1, wherein one or both of the first and second binding constructs comprise a primer sequence.

15. The method of claim 13, further comprising the step of amplifying the binding event identifier after the creating step and before the determining step.

16. The method of claim 1, wherein at least one of the first and second binding agents is a peptide.

17. The method of claim 16, wherein the first and second binding agents are peptides.

18. The method of claim 16, wherein the second binding agent is an antibody.

19. The method of claim 16, wherein the second binding agent is a small molecule.

20. The method of claim 1, wherein the first or second binding agent is an aptamer.

21. The method of claim 20, wherein the first binding agent is a peptide and the second binding agent is an aptamer.

22. The method of claim 1, wherein the support is a microarray.

23. The method of claim 1, wherein the support is a bead.

24. The method of claim 1, further comprising the step of adding a third binding agent in the combining step.

25. The method of claim 1, further comprising the step of identifying binding agents that bind promiscuously.

26. The method of claim 25, wherein data from promiscuous binding agents is subtracted from binder identifier results of the determining step.

27. The method of claim 25, wherein a quantitative metric can be derived for the extent of promiscuity of promiscuous binding agents.

28. The method of claim 1, wherein false positives are identified within the binding event identifiers and data from the false positives subtracted from binder identifier results of the determining step.

29. The method of claim 1, further comprising the step of determining the number of each binding event identifier sequenced.

30. A method for identifying binding agents that form a binding pair, comprising:
providing a first set of binding constructs immobilized on a support surface, wherein each binding construct of the first set of binding constructs comprises a first binding agent, a first primer region and a first nucleic acid tag unique to the first binding agent;
providing a second set of binding constructs in solution, wherein each binding construct of the second set of binding constructs comprises a second binding agent, a second primer region and a second nucleic acid tag unique to the second binding agent, and wherein either or both of the first and second sets of binding constructs comprises at least ten different binding agents;
combining the first and second sets of binding constructs under conditions to allow the first binding agents and the second binding agents to form binding pairs, thereby co-locating the first nucleic acid tags and the second nucleic acid tags;
creating binding event identifiers from the co-located first and second nucleic acid tags;
determining a sequence of at least one thousand binding event identifiers, wherein the sequence of each binding event identifier identifies the binding pair and the binding agents that form the binding pair; and
determining the frequency of each binding event identifier sequenced.

31. The method of claim 30, wherein the sequences of the binding event identifiers are determined in parallel.

32. The method of claim 31, wherein the sequence of at least one thousand binding event identifiers are determined in parallel.

33. The method of claim 32, wherein the sequence of at least one hundred thousand binding event identifiers are determined in parallel.

34. A method for characterizing the specificity of binding between binding agents that form a binding pair, comprising:
providing a first set of binding constructs immobilized on a support surface, wherein each binding construct of the first set of binding constructs comprises a first binding agent, a first primer region and a first nucleic acid tag unique to the first binding agent;
providing a second set of binding constructs in solution, wherein each binding construct of the second set of binding constructs comprises a second binding agent, a second primer region and a second nucleic acid tag unique to the second binding agent, and wherein either or both of the first and second sets of binding constructs comprises at least ten different binding agents;
combining the first and second sets of binding constructs under conditions to allow the first binding agents and the second binding agents to form binding pairs, thereby co-locating the first nucleic acid tags and the second nucleic acid tags;
creating binding event identifiers from the co-located first and second nucleic acid tags; and
determining a sequence of the binding event identifiers; wherein the sequence of the binding event identifier identifies the binding pair and the binding agents that form the binding pair.

35. The method of claim 34, wherein the sequence of at least one thousand binding event identifiers are determined in parallel.

36. The method of claim 35, wherein the sequence of at least one hundred thousand binding event identifiers are determined in parallel.

37. The method of claim 34, further comprising the step of amplifying the binding event identifier after the creating step and before the determining step.
